(19) United States
(12) Patent Application Publication
(10) Pub. No.: US 2020/0357212 A1
(43) Pub. Date: Nov. 12, 2020

(54) System and Method for Controlling the Access of Persons

(71) Applicant: Siemens Schweiz AG, Zürich (CH)

(72) Inventor: Christian Frey, Unterägeri (CH)

(73) Assignee: Siemens Schweiz AG, Zürich (CH)

(21) Appl. No.: 16/761,077

(22) PCT Filed: Oct. 30, 2018
(86) PCT No.: PCT/EP2018/079647

§ 371 Date: May 1, 2020

(30) Foreign Application Priority Data
Nov. 3, 2017 (DE) 10 2017 219 533.9

(51) Int. Cl. G07C 9/28; G07C 9/27; G07C 9/29

(52) U.S. Cl. CPC G07C 9/28; G07C 2209/63; G07C 9/29; G07C 9/27

(57) ABSTRACT

Various embodiments include access systems at physical access regions comprising: an identification medium including an identification code assigned to a particular person; a reading device for determining the identification code from the identification medium disposed at a device location corresponding to a physical access region and configured to send the identification code and the device location to an access control server; a positioning device for determining a user location of a mobile device assigned to the person; and the access control server. The control server is programmed to: receive the identification code from the reading device and the user location from the positioning device; compare the user location to the device location; and generate an access authorization for the person if the user location and the device location match and a positive authentication of the person on the basis of the identification code has been established.

### CROSS-REFERENCE TO RELATED APPLICATIONS

This application is a U.S. National Stage Application of International Application No. PCT/EP2018/079647 filed Oct. 30, 2018, which designates the United States of America, and claims priority to DE Application No. 10 2017 219 533.9 filed Nov. 3, 2017, the contents of which are hereby incorporated by reference in their entirety.

### TECHNICAL FIELD

The present disclosure relates to security. Various embodiments may include systems and/or methods for controlling the access of persons at physical access regions.

### BACKGROUND

For the purpose of authentication on an access control system e.g. at a building, physical media (RFID key, permit) in conjunction with a permit reader or RFID reader or similar are generally used to authenticate a person seeking access. If the physical medium (e.g. a company pass) is recognized and the corresponding authorization has been provided in the system, access is granted. If a permit is lost, anybody holding the permit is granted access. There is therefore a risk of unauthorized persons being present in a secure area.

The use of multi-factor authentication, in particular two-factor authentication (identification of a person using two different factors, e.g. ID card and PIN (secret number)), also does not always permit secure authentication, since both factors can be wrongfully obtained by another person in order to gain unauthorized access. Furthermore, multi-factor authentication systems are often inconvenient and time-consuming for a user.

### SUMMARY

The teachings of the present disclosure may be used to provide a mechanism for simple and secure authentication of a person on an access control system. For example, some embodiments include a system for controlling the access of persons at physical access regions (e.g. gate, door), said system comprising: an identification medium (e.g. badge, permit, RFID chip) having an identification code (e.g. identification number, ID no.) assigned to a person; a reading device (e.g. a card reader) for reading the identification code, wherein the reading device is located at a physical access region (e.g. gate, door), and wherein the reading device is configured to send the identification code read and the location of the reading device to an access control server; a positioning device (e.g. a satellite-based positioning device such as e.g. GPS or Galileo, or an indoor positioning device such as e.g. WLAN or IBeacons) for determining the location (OPG) of a mobile device (e.g. mobile communication terminal such as a smartphone, tablet computer or iPod) assigned to the person; and an access control server, wherein the access control server is configured to receive the identification code of the identification medium and the location of the mobile device, to compare the received location of the mobile device with the location of the reading device, and to generate an access authorization for the person if the location of the mobile device assigned to the person and the location of the reading device match, and if a positive authentication of the person on the basis of the identification code has been established.

Some embodiments include a system for controlling the access of persons (P) at physical access regions (T), said system comprising: an identification medium (IM) having an identification code (IC) assigned to a person; a reading device (LV) for reading the identification code (IC), wherein the reading device (LV) is located at a physical access region (T), and wherein the reading device (LV) is configured to send the identification code (IC) read and the location (OPL) of the reading device (LV) to an access control server (ZKS); a positioning device (SAT, IPS) for determining the location (OPG) of a mobile device (MG) assigned to the person (P); and an access control server (ZKS), wherein the access control server is configured to receive the identification code (IC) of the identification medium (IM) and the location (OPG) of the mobile device (MG), to compare the received location (OPG) of the mobile device (MG) with the location (OPL) of the reading device (LV), and to generate an access authorization (ZA) for the person (P) if the location (OPG) of the mobile device (MG) assigned to the person (P) and the location (OPL) of the reading device (LV) match, and if a positive authentication of the person (P) on the basis of the identification code (IC) has been established.

In some embodiments, the access control server (ZKS) is realized in a cloud infrastructure (C).

In some embodiments, the positioning device (SAT, IPS) is configured to send the location (OPG) of the mobile device (MG) to the access control server (ZKS).

In some embodiments, the mobile device (MG) is configured to send the location (OPG) of the mobile device (MG) to the access control server (ZKS).

In some embodiments, the positioning device (SAT, IPS) is configured to determine the location (OPG) of the mobile device (MG) assigned to the person (P) on the basis of satellites.

In some embodiments, the positioning device (SAT, IPS) is configured to determine the location (OPG) of the mobile device (MG) assigned to the person (P) on the basis of the cell information of a mobile network.

In some embodiments, the positioning device (SAT, IPS) is configured to determine the location (OPG) of the mobile device (MG) assigned to the person (P) on the basis of IPS data.

In some embodiments, an access authorization (ZA) is provided for the person (P) by means of the access control server (ZKS) if the location (OPG) of the mobile device (MG) assigned to the person (P) and the location (OPL) of the reading device (LV) match, and a positive authentication of the person (P) on the basis of the identification code (IC) has occurred, wherein the location (OPG) of the mobile device (MG) assigned to the person (P) is provided by two different positioning devices (SAT, IPS).

In some embodiments, the two different positioning devices (SAT, IPS) determine the location (OPG) of the mobile device (MG) assigned to the person (P) in each case on the basis of different technologies or different positioning methods.

As another example, some embodiments include a method for controlling the access of persons (P) at access regions (T), said method comprising the following steps: (VS1) the person (P) is authenticated by means of an access control device (ZKS) on the basis of an identification medium (IM) assigned to the person (P); the location (OPG) of a mobile device (MG) assigned to the person (P) is determined; the location (OPG) of the mobile device (MG) is transmitted to the access control device (ZKS); and the location (OPG) of the mobile device (MG) is checked with the location (OPL) of the corresponding access region (T) by means of the access control device (ZKS), wherein an access authorization (ZA) is provided for the person (P) if the location (OPG) of the mobile device (MG) assigned to the person (P) and the location (OPL) of the corresponding access region (T) match and a positive authentication of the person (P) on the basis of the identification medium (IM) assigned to the person (P) has occurred.

In some embodiments, the location (OPG) of the mobile device (MG) assigned to the person (P) is determined by means of two different positioning technologies or by means of two different positioning devices (SAT, IPS).

### BRIEF DESCRIPTION OF THE DRAWINGS

The teachings of the present disclosure and various embodiments of the teachings will now be described in greater detail by reference to the accompanying drawings, in which:

FIG. 1 shows an example of a system for controlling the access of persons at physical access regions incorporating teachings of the present disclosure; and

FIG. 2 shows a flow diagram for an example method for controlling the access of persons at physical access regions incorporating teachings of the present disclosure.

### DETAILED DESCRIPTION

By determining the location of the mobile device (e.g. smartphone) of the person seeking access, plausibility may be established automatically between the identification medium (e.g. badge, permit, RFID chip) at the physical access region(s) (e.g. gate, door) and the location of the mobile device. Various location-determining or positioning technologies can be used here, such as e.g. GPS coordinates, cell information for the mobile device (e.g. smartphone), or WLAN-ID of the WLAN access point installed in the vicinity of the corresponding reading device. In some embodiments, the access control server comprises a correlation table for checking whether the two authentication factors (identification code and the location of the reading device) match. In some embodiments, the correlation table is stored in an in-memory database (IMDB) in the working memory of the access control server. Inter alia this allows fast access and checking times.

Multiple physical access regions can be located at a building or a spatial region to allow persons to enter. In some embodiments, each of these access regions is equipped with a corresponding reading device or a corresponding positioning device.

In some embodiments, the identification medium (e.g. badge, permit, RFID chip, identity card) and the identification code (e.g. identification number, ID no.) assigned to a person are issued by a secure and trustworthy instance (e.g. a function set up accordingly in the personnel department of a company), and the identification code assigned to a person is generated by secure mechanisms (e.g. by corresponding cryptographic or statistical methods) and stored on the identification medium in tamper-proof form.

Two-factor authentication for controlling the access of persons, using the combination of two different and, in particular, independent components, increases security since it is highly probable that access will be prevented for unauthorized persons.

In some embodiments, the access control server comprises a cloud infrastructure. As such, the access authorization can be provided e.g. as SaaS (software as a service) for a service user (e.g. for a company wishing to establish a corresponding multi-step or two-step access authorization procedure for its company buildings or its campus).

In some embodiments, the positioning device may be configured to send the location of the mobile device to the access control server. The positioning device can determine the location of the mobile device, e.g. by means of the WLAN-ID of a WLAN access point, and send it to the access control server via a secure communication connection. In this case, only the infrastructure of the access control system is used for the purpose of positioning, and transmitting the position data to the access control server. Third-party attacks (e.g. man-in-the-middle attacks) are made more difficult as a result.

In some embodiments, the mobile device may be configured to send the location of the mobile device to the access control server. This may be advantageous if the mobile device is a work mobile phone or company mobile phone equipped with corresponding software and security mechanisms.

In some embodiments, the positioning device may be configured to use satellite-based positioning (GPS, Galileo) to determine the location of the mobile device assigned to the person. Satellite-based positioning is suitable for use in particular if the reading device is located outside a building—e.g. at the access control point for a fenced-off site (e.g. military barracks).

In some embodiments, the positioning device may be configured to determine the location of the mobile device assigned to the person on the basis of the cell information of a mobile network (e.g. GSM). In towns and cities and built-up areas in particular, the cellular mobile network is very dense. Determining the location of a mobile device (e.g. mobile communication terminal, smartphone) with sufficient precision is therefore possible.

In some embodiments, the positioning device may be configured to determine the location of the mobile device assigned to the person on the basis of IPS data (indoor positioning, WiFi access points, IBeacons, Bluetooth, etc.). The location can therefore be determined using infrastructure that is already present anyway at the access region to be controlled, or an indoor positioning device (WiFi access points, IBeacons, Bluetooth, etc.) can be installed very easily.

In some embodiments, there is an access authorization for the person by means of the access control server if the location of the mobile device assigned to the person and the location of the reading device match, and a positive authentication of the person on the basis of the identification code (ID no.) has occurred, wherein the location of the mobile device assigned to the person is provided by two different positioning devices. If the location of the mobile device assigned to the person is determined by two different positioning devices independently and access is only granted if, in the event of a positively recognized identification code, the locations determined by the two different positioning devices independently also match, there is a very high degree of security or probability that access will be prevented for unauthorized persons. Furthermore, it is therefore very easy to extend a two-factor authentication to a three-factor authentication.

In some embodiments, the two different positioning devices determine the location of the mobile device assigned to the person in each case on the basis of different technologies or different positioning methods. If the location of the mobile device assigned to the person is determined by two different positioning devices independently, each of which is based on different technologies, and access is only granted if, in the event of a positively recognized identification code, the locations determined by the two different positioning devices independently also match, there is a very high degree of security or probability that access will be prevented for unauthorized persons. As a result, it is once again therefore very easy to extend a two-factor authentication to a three-factor authentication.

Some embodiments include a method for controlling the access of persons at access regions (e.g. gate, door), said method comprising the following steps: the person is authenticated by means of an access control device on the basis of an identification medium (badge, RFID chip) assigned to the person; the location of a mobile device (e.g. mobile communication terminal such as a smartphone or iPod) assigned to the person is determined; the location of the mobile device is transmitted to the access control device; the location of the mobile device is checked with the location of the corresponding access region by means of the access control device, wherein an access authorization is provided for the person if the location of the mobile device assigned to the person and the location of the corresponding access region match and a positive authentication of the person on the basis of the identification medium (badge, RFID chip) assigned to the person has occurred. The method can be realized using infrastructure that is already present anyway at access regions (gate, door, etc.) to be secured, or can easily be retrofitted.

In some embodiments, the method is realized using commercially available hardware (computers, storage devices, communication mechanisms, etc.) and/or software components (e.g. spreadsheets, databases). By means of the method, it is very easy to realize a two-factor authentication for controlling the access of persons, which can easily be extended to a three-factor authentication or multi-factor authentication.

In some embodiments, the location of the mobile device assigned to the person may be determined by means of two different positioning technologies or by means of two different positioning devices. If the location of the mobile device assigned to the person is determined by two different positioning devices or by two different positioning technologies, in each case independently, and access is only granted if, in the event of a positively recognized identification code, the locations determined independently also match, there is a very high degree of security or probability that access will be prevented for unauthorized persons.

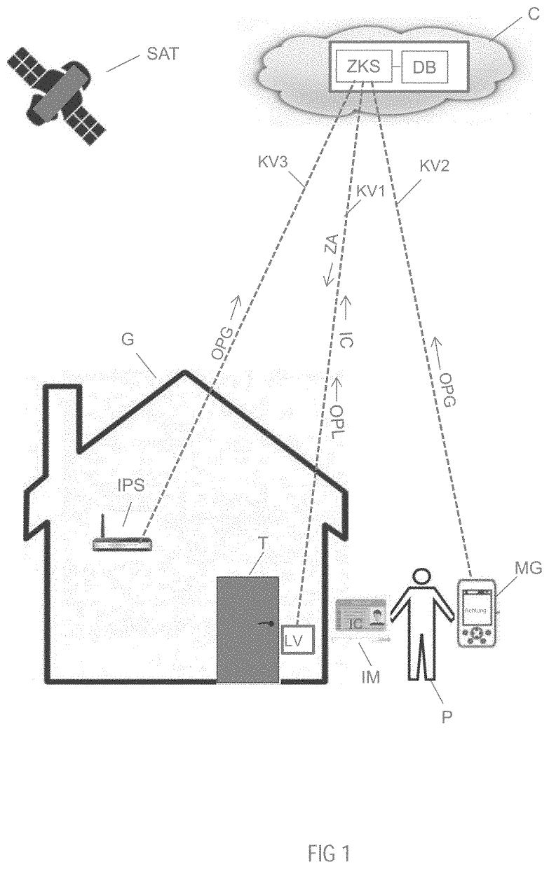

FIG. 1 shows an example system for controlling the access of persons at physical access regions (e.g. gate, doors). The example system comprises: an identification medium IM (e.g. badge, permit, RFID chip) having an identification code IC (e.g. unique machine-readable code) assigned to a person P; a reading device LV for reading the identification code IC, wherein the reading device LV is located at a physical access region T (e.g. gate, door), and wherein the reading device LV is configured to send the identification code IC read and the location OPL of the reading device LV to an access control server ZKS; a positioning device SAT, IPS for determining the location of a mobile device MG (e.g. mobile communication terminal such as a smartphone, tablet computer or iPod) assigned to the person P; and an access control server ZKS configured to receive the identification code IC of the identification medium IM and the location of the mobile device MG. The access control server ZKS is also configured to compare the received location OPG of the mobile device MG with the location OPL of the reading device LV, wherein an access authorization for the person P is generated by means of the access control server ZKS if the location OPG of the mobile device MG assigned to the person P and the location OPL of the reading device LV match, and if a positive authentication of the person P on the basis of the identification code IC has occurred.

In order to determine the respective position OPL, OPG e.g. an indoor positioning system IPS can be used, such as e.g. BLE Beacon (Bluetooth low energy beacon), RFID (Radio Frequency Identification), NFC (Near Field Communication), WLAN SSID (Service Set Identifier), or a global positioning system (GPS, Galileo) SAT that works on the basis of satellites. In order to determine the position OPL, OPG a combined system, e.g. based on GPS and IPS, can also be used. However, it is also possible for the indoor positioning system IPS and the global positioning system (GPS) SAT to work independently, i.e. to determine the respective location OPL, OPG independently.

The physical access region can be an entrance to a building G or a room in a building, or the entrance to a closed-off (e.g. fenced-off) area (e.g. campus, military barracks).

The identification medium IM for a person P can be e.g. a badge, permit or RFID chip assigned to that person. A mobile communication terminal (e.g. smartphone), which is assigned to the person and is equipped accordingly with an app or credentials (proof of entitlement, authorization), could also be used as an identification medium IM.

An identification code IC that is unique to the person is assigned to the identification medium IM. E.g. an employee number of identification number. In some embodiments, the identification code IC is encrypted and can be decrypted by corresponding software in the access control server ZKS. In some embodiments, the identification code IC is machine-readable (e.g. barcode, QR code, chip on permit).

In order to read the identification code IC, e.g. the identification medium IM (e.g. permit as IC card) can be inserted into the reading device LV in a corresponding opening in the reading device LV. However, the identification code IC can also be read contactlessly from the identification medium IM by means of the reading device LV e.g. by means of a corresponding optical device (e.g. for reading barcodes or QR codes) or e.g. by means of a radio-based device (e.g. RFID reader), depending on the identification medium IM used or the identification code IC used.

The access control server ZKS is connected to the reading device LV, to the positioning device SAT, IPS and to the mobile device MG in each case by means of corresponding communication connections KV1-KV3 for the exchange of data/information. The communication connections KV1-KV3 can be e.g. satellite-based connections or radio connections. The access control server ZKS is equipped with corresponding hardware and software components. In some embodiments, the access control server ZKS comprises a database DB that includes e.g. a correlation table for checking whether the authentication factors (identification code, location of the reading device, location of the mobile device) match. The database DB can be e.g. a relational database configured accordingly. However, the correlation table can also be stored in an in-memory database (IMDB) in the working memory of the access control server ZKS.

After successful authentication by means of the access control server ZKS, the access control server sends a corresponding access authorization ZA (e.g. a corresponding signal (e.g. flag, credential) to open the door T) to the reading device LV or directly to the access mechanism of the door T. In some embodiments, the access control server ZKS is realized in a cloud infrastructure.

In some embodiments, the positioning device SAT, IPS is configured to send the location OPG of the mobile device MG to the access control server ZKS. In some embodiments, the mobile device MG (e.g. smartphone) is configured to send the location OPG of the mobile device MG to the access control server ZKS. In some embodiments, the positioning device SAT, IPS is configured to determine the location OPG of the mobile device MG assigned to the person P on the basis of satellites (e.g. by means of GPS or Galileo).

In some embodiments, the positioning device SAT, IPS is configured to determine the location OPG of the mobile device MG assigned to the person P on the basis of the cell information of a mobile network (e.g. GSM). In some embodiments, the positioning device SAT, IPS is configured to determine the location OPG of the mobile device MG assigned to the person P on the basis of IPS data (indoor positioning, WiFi access points, IBeacons).

In some embodiments, an access authorization ZA is provided for the person P by means of the access control server ZKS if the location OPG of the mobile device MG assigned to the person P and the location OPL of the reading device LV match, and a positive authentication of the person P on the basis of the identification code IC has occurred, wherein the location OPG of the mobile device MG assigned to the person P is provided by two different positioning devices SAT, IPS.

In some embodiments, the two different positioning devices determine the location of the mobile device MG assigned to the person P in each case on the basis of different technologies. This increases security in access control; in other words it is highly probable that access will be prevented for unauthorized persons.

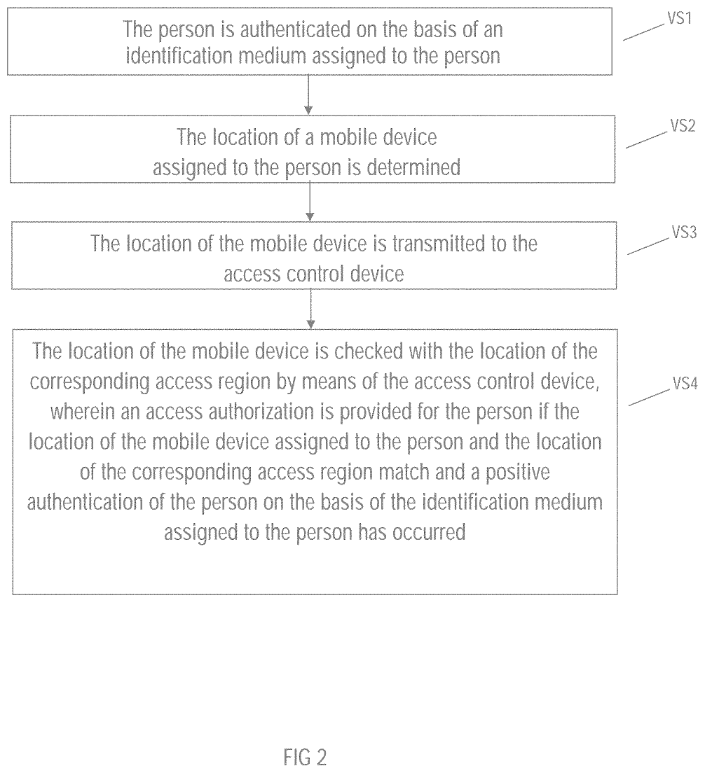

FIG. 2 shows a flow diagram for an example method for controlling the access of persons at physical access regions (e.g. gate, door). The access control method shown comprises the following steps: (VS1) the person is authenticated by means of an access control device on the basis of an identification medium (e.g. badge, RFID chip) assigned to the person; (VS2) the location of a mobile device (e.g. mobile communication terminal such as a smartphone or iPod) assigned to the person is determined; (VS3) the location of the mobile device is transmitted to the access control device; and (VS4) the location of the mobile device is checked with the location of the corresponding access region by means of the access control device, wherein an access authorization is provided for the person if the location of the mobile device assigned to the person and the location of the corresponding access region match and a positive authentication of the person on the basis of the identification medium (e.g. badge, RFID chip) assigned to the person has occurred. The method can be realized using infrastructure that is already present anyway at access regions (gate, door, etc.) to be secured, or can easily be retrofitted.

In some embodiments, the method is realized using commercially available hardware (computers, storage devices, communication mechanisms, etc.) and/or software components (e.g. spreadsheets, databases). By means of the method, it is very easy to realize a two-factor authentication for controlling the access of persons, which can easily be extended to a three-factor authentication or multi-factor authentication. The access control device can be realized e.g. by means of a correspondingly configured server, which may be located in a cloud infrastructure and, by means of corresponding communication mechanisms and using data technology, is connected to and communicates with the mobile device, the reading device and/or the positioning system.

In some embodiments, the location of the mobile device assigned to the person is determined by means of two different positioning technologies or by means of two different positioning devices. If the location of the mobile device assigned to the person is determined by two different positioning devices or by two different positioning technologies, in each case independently, and access is only granted if, in the event of a positively recognized identification code, the locations determined independently also match, there is a very high degree of security or probability that access will be prevented for unauthorized persons.

In some embodiments, the identification medium (e.g. IC card, permit) comprises an identification code assigned uniquely to the person (e.g. unique ID number) that can be read by a reading device and can be forwarded by the reading device to the access control device. From a structural perspective, the reading device can also be integrated in the access control device. In some embodiments, the reading device is located in the access region itself or in the direct vicinity of the access region (e.g. at a distance lying in the range between 5 cm and 5 m, in particular between 50 cm and 3 m). By determining the location of the mobile device (e.g. smartphone) of the person seeking access, plausibility is established automatically between location of a reading device (e.g. permit reader at a door/gate) and the location of the mobile device.

Various location-determining or positioning technologies can be used here:
1. GPS coordinates, which, for example, can also be transmitted by telephone on request to the access control server.
2. Cell information for the mobile device (e.g. smartphone), which, for example, can be transmitted by telephone on request to the access control server.
3. WLAN-ID of the WLAN access point installed in the vicinity of the corresponding reading device (e.g. access reader). A correlation table stored on an access control server checks automatically whether the two or more authentication factors match.

At doors secured accordingly, lost permits “automatically” become invalid because the 2nd characteristic feature is missing. Manual locking of the permit in the system is not required, with a new permit being issued for the person immediately. Security against unauthorized access is increased as a result. Back doors in particular, at which there is usually no security guard present, benefit from increased security as a result. If the permit is found again at a later point, it can be used again in conjunction with the other authentication steps.

Checking of 2-step authentication is performed automatically in the system. There is no further need to enter or provide a credential.

### REFERENCE CHARACTERS

SAT Satellite
LV Reading device
IPS Positioning system
G Building
T Door
KV1-KV3 Communication connection
MG Mobile device
IM Identification medium
IC Identification code
P Person
C Cloud
ZKS Access control server
DB Database
OPG Location of the mobile device
OPL Location of the reading device
ZA Access authorization
VS1-VS4 Method step

What is claimed is:

1. A system for controlling the access of persons at physical access regions, the system comprising:
an identification medium including an identification code assigned to a particular person;
a reading device for determining the identification code from the identification medium, the reading device disposed at a device location corresponding to a physical access region, and configured to send the identification code and the device location to an access control server;
a positioning device for determining a user location of a mobile device assigned to the person; and
the access control server configured to:
receive the identification code from the reading device and the user location from the positioning device;
compare the user location to the device location; and
generate an access authorization for the person if the user location and the device location match and a positive authentication of the person on the basis of the identification code has been established.

2. The access control system as claimed in claim 1, wherein the access control server comprises a cloud infrastructure.

3. The access control system as claimed in claim 1, wherein the positioning device sends the user location to the access control server (ZKS).

4. The access control system as claimed in claim 1, wherein the mobile device sends the user location to the access control server.

5. The access control system as claimed in claim 1, wherein the positioning device determines the user location with satellites.

6. The access control system as claimed in claim 1, wherein the positioning device determines the user location on the basis of thc cell information of a mobile network.

7. The access control system as claimed in claim 1, wherein the positioning device determines the user location on the basis of IPS data.

8. The access control system as claimed in claim 1, wherein:
the access control server provides an access authorization for the person if the user location and the device location match, and a positive authentication of the person on the basis of the identification code has occurred; and
the user location is confirmed by two different positioning devices.

9. The access control system as claimed in claim 8, wherein the two different positioning devices determine the user location on the basis of at least two different technologies or different positioning methods.

10. A method for controlling the access of persons at access regions, thes method comprising:
authenticating the person using an access control device using an identification medium assigned to the person, wherein the identification medium includes a person identification code;
determine a user location using a mobile device assigned to the person;
transmitting the user location to the access control device;
checking the user location for correspondence to the device location of the respective access region using the access control device; and
providing access authorization for the person if the user location and the device location match and a positive authentication of the person on the basis of the identification medium assigned to the person has occurred.

11. The method as claimed in claim 10, further comprising determining the user location with two different positioning technologies or two different positioning devices.
